(19) United States
(12) Patent Application Publication
(10) Pub. No.: US 2010/0326847 A1
(43) Pub. Date: Dec. 30, 2010

(54) Monolithic Polymer Materials for Gas Storage

(75) Inventors: Gerhard Jonschker, Heppenheim (DE); Matthias Koch, Wiesbaden (DE); Joerg Pahnke, Darmstadt (DE); Matthias Schwab, Neustadt/Weinstrasse (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 12/865,420

(22) PCT Filed: Jan. 14, 2009
(86) PCT No.: PCT/EP09/00159

§ 371 Date: Jul. 30, 2010

(30) Foreign Application Priority Data
Jan. 31, 2008 (DE) 10 2008 006 874.8

(51) Int. Cl. F17C 11/00; C08J 9/00

(52) U.S. Cl. 206/7; 521/142; 521/146

(57) ABSTRACT

The invention relates to a porous polymeric monolith based on a polymerised high internal phase emulsion (polyHIPE) which is hypercrosslinked, and to the preparation and use thereof, preferably as gas storage material.

The invention relates to a porous polymeric monolith based on a polymerised high internal phase emulsion (polyHIPE) which is hypercrosslinked, and to the preparation and use thereof, preferably as gas storage material.

The storage of gases, in particular hydrogen, is of increasing economic importance. Materials which are able to adsorb the gases on a large surface allow the construction of gas tanks without high-pressure or cryotechnology. This is intended to provide the basis for conversion of the vehicles powered today with liquid fuel to environmentally friendly or even environmentally neutral gaseous fuels. The gaseous fuels with the greatest existing and future economic and political potential have been identified as natural gas/methane and hydrogen.

The state of the art today in gas-powered vehicles is pressurised storage in steel bottles and to a small extent in composite bottles. The storage of natural gas in CNG (compressed natural gas) vehicles takes place at a pressure of 200 bar. In most prototypes of hydrogen-powered vehicles, pressurised storage systems with 350 bar or to a small extent cryogenic liquid hydrogen systems at −253° C. (20 K) are used. As a future solution, pressurised systems for 700 bar which have a volume-based storage density comparable to liquid hydrogen are already being developed. Common features of these systems are still low volume efficiency and high weight, which restricts the range of the vehicles to about 350 km (CNG vehicles) or 250 km (hydrogen vehicles). Furthermore, the high energy expenditure for compression and in particular liquefaction represents a further disadvantage which reduces the possible ecological advantages of gas-powered vehicles. In addition, the tank design must take into account storage at very low temperatures (20 K) by means of extreme insulation. Since complete insulation cannot be achieved, a considerable leakage rate in the order of 1-2% per day must be expected in the case of such tanks. Taking into account the above-mentioned energetic and economic (infrastructure costs) aspects, pressurised storage is regarded as the most promising technology in the foreseeable future for the gaseous fuels natural gas (CNG) and later hydrogen.

An increase in the pressure level to above 200 bar in the case of CNG would be difficult to imagine in technical and economic terms since an extensive infrastructure and rapidly growing vehicle stock of currently about 50,000 cars already exist in Germany now. Thus, potential solutions for increasing the storage capacity remain optimisation of the tank geometry (avoidance of individual bottles, structural tank in “cushion shape”) and an additional, supporting storage principle, such as adsorption.

This potential solution could also be applied to hydrogen, where even greater advantages would be expected than in the case of natural gas. The reason for this is the real gas behaviour of hydrogen (real gas factor Z>1), as a consequence of which the physical storage capacity only increases sub-proportionately with the pressure.

Chemical storage in metal-hydride storage media is already very well advanced. However, high temperatures arise during charging of the storage media and have to be dissipated in a short time during filling of the tank. Correspondingly high temperatures are necessary during discharge in order to expel the hydrogen from the hydrides. Both require the use of considerable amounts of energy for cooling/heating, which impairs the efficiency of the storage media. These disadvantages are caused by the thermodynamics of storage. In addition, the kinetics of hydride-based hydrogen storage media are poor, which increases the time needed for filling the tank and makes the provision of hydrogen during operation more difficult. Materials having faster kinetics are known (for example alanates), but they are pyrophoric, which limits use in motor vehicles.

Besides conventional pressurised storage, essentially three concepts are currently under discussion for hydrogen storage: cryostorage, chemical storage media and adsorptive storage [see L. Zhou, Renew. Sust. Energ. Rev. 2005, 9, 395-408]. Cryostorage (liquid hydrogen) is technically complex and associated with high evaporation losses, while chemical storage using hydrides requires additional energy for decomposition of the hydride, which is frequently not available in the vehicle. An alternative is adsorptive storage, in which the gas is adsorbed in the pores of a nanoporous material. The density of the gas inside the pores is thus increased. In addition, desorption is associated with a self-cooling effect, which is advantageous for adsorptive cryostorage. However, the heat flows during adsorption and desorption are much smaller than in the case of hydrides and therefore do not represent a fundamental problem.

Various classes of material are basically suitable for gas or hydrogen storage owing to their high specific surface areas and their pronounced microporosity:
active carbons (see Panella et al., Carbon 2005, 43, 2209-2214)
carbon nanotubes (CNTs) (see Schimmel et al., Chem. Eur. J. 2003, 9, 4764-4770)
zeolites and other silicate materials (see Jansen et al., Chem. Eur. J. 2007, 13, 3590-3595)
metal-organic framework materials (MOFs) (see Zao et al., Science 2004, 306, 1012-1015)
covalent-organic framework materials (COFs) (see El-Kaderi et al., Science 2007, 316, 268-272)
polymeric intrinsic microporosity (PIM) (see Budd et al., Phys. Chem. Chem. Phys. 2007, 9, 1802-1808)
hypercrosslinked polymers (HCPs) (see Budd et al., Phys. Chem. Chem. Phys. 2007, 9, 1802-1808)

Active carbons having optimised pore geometry achieve measurement results of 45.0 g of H₂/kg at 70 bar by physisorption of hydrogen (see Carbon 2005, 43, 2209-2214). For other highly porous carbon materials derived from carbide compounds (CDCs), storage capacities in the region of 30 g of H₂/kg or 24 g of H₂/kg at 1 bar are currently described (see Adv. Funct. Mater. 2006, 16, 2288-2293). For zeolites, values of 18.1 g of H₂/kg at 15 bar have been measured (see J. Alloys Compd. 2003, 356-357, 710-715). High gravimetric storage capacities of 75 g of H₂/kg for MOF-177 and 67 g of H₂/kg for IRMOF-20 in the pressure range from 70-80 bar have recently been published (see Zao et al., Science 2004, 306, 1012-1015).

In the case of highly porous polymer materials, which have recently been investigated to an increased extent owing to their relatively high energy density, it is frequently desirable for these materials to be in monolithic form, inter alia because this form allows simpler handling than in the case of powders.

To date, highly porous polymer materials have been prepared, for example, by strong crosslinking (hypercrosslinking) of swollen, lightly crosslinked polymer particles, in particular based on polystyrene (see Davankov et al., Reactive & Functional Polymers 53 (2002) 193-203). In these so-called Davankov networks, a basic distinction is made between gelatinous and macroporous precursor polymers (see. Sherrington, Chem. Commun. 1998, 2275-2286), which are prepared by suspension polymerisation in water and are in the form of a finely dispersed powder in the dry state. Owing to their low crosslinking agent content (less than 20 mol %), the gelatinous Davankov networks have low mechanical stability in the swollen state, which restricts their application. Although fairly high specific surface areas can be produced in these networks due to hypercrosslinking, it is not the total surface area alone that is crucial for gas storage purposes, but instead, in particular, the proportion emanating from pores in the (ultra)micro range.

The object of the present invention was therefore to develop a monolithic, open-pored storage material having a continuous network structure and a bimodal pore-size distribution which has transport and storage pores (hierarchical pore structure), which can be installed in the form of blocks or cylinders in tanks and thus do not have the above-mentioned disadvantages.

The present object is achieved by the preparation of open-pored polymer foams in the form of monoliths based on a high internal phase emulsion (polyHIPE), which are subsequently hypercrosslinked. During the hyper-crosslinking, both the monolithic shape and also the continuous pore structure are surprisingly retained.

The present invention thus relates to a porous polymeric monolith obtainable by polymerisation of a high internal phase emulsion (HIPE) comprising:
a. a continuous oil phase which comprises at least one ethylenically unsaturated monomer, and
b. an aqueous phase comprising at least one initiator and at least one electrolyte,
   where the resultant porous polymer or the open-pored polymer foam (also known as polyHIPE), comprising a polymer phase and pores, is subsequently hypercrosslinked to give additional crosslinking bridges.

A polymeric monolith or polymeric monolithic moulded body is, in accordance with the invention, a three-dimensional body comprising a porous polymer foam, for example in the form of a column, cuboid, sphere, sheet, fibre, regularly or irregularly shaped particle or other forms of any desired irregular shape. The term monolith or monolithic moulded body also includes a layer of the material, for example on a surface or in a void.

The term “HIPE” (high internal phase emulsion) is taken to mean an emulsion in which the dispersed phase (here water) takes up a greater volume, usually more than 74%, preferably 75 to 90% by vol., of the total volume, than the continuous phase (for example styrene or divinylbenzene). On curing by polymerisation of the continuous phase, an open-pored polymer foam forms, which is then, strictly speaking, no longer an emulsion and is also referred to in the literature as “polyHIPE” (see Cameron et al, Polymer 2005, 46, 1439-1449).

PolyHIPEs have an accessible network with a continuous pore structure and a high pore volume. This structure consists of voids, which are inter-connected by windows. The size of the voids is in the double-digit micron range, while the windows have a smaller diameter. Conventional polyHIPEs (i.e. not hypercrosslinked) have specific surface areas of 10-30 m²/g. An emulsion consists of two immiscible phases, which are also known as the water and oil phase. In order to produce a stable emulsion and to prevent premature phase separation of the components, a crosslinking agent (surfactant) must be added to the system. Furthermore, the process of droplet formation during preparation of the emulsion is supported by vigorous stirring. During the widespread emulsion polymerisation, the internal phase (droplet phase) of the system is polymerised to completion. The resultant latex comprises finely divided polymer particles of colloidal dimensions.

By contrast, the reverse procedure is followed in the preparation of polyHIPEs. The continuous phase remains after removal of the internal phase and forms the polymeric wall material of the monolith. The emulsion droplets originally present leave behind the typical spherical voids in the material after drying. The windows form at the points where the droplets in the emulsion are in contact with one another (see Cooper et al, Soft Matter 2005, 1, 107-113). Parameters which, besides the actual chemical properties of the components, influence the stability of an emulsion are, inter alia, the substance amounts employed and their ratio to one another, the temperature and the electrolyte concentration in the aqueous phase.

In accordance with the invention, the polyHIPEs are produced via an inverse water-in-oil emulsion, but an inverse oil-in-water emulsion can also in principle serve as template.

The polyHIPEs according to the invention can be prepared either by free-radical polymerisation or by polycondensation.

These polyHIPEs are subsequently hypercrosslinked, preferably via a multiple Friedel-Crafts alkylation, with the aim of producing a microporous polymer monolith which has a hierarchical pore distribution. The primary porosity in the macropore range which is already present due to the polyHIPE should favour transport of the adsorbate to the microporous framework of the material here.

The concept of transport pores is in principle also found when considering the structure of the human lung, where the regions of the alveoli that are crucial for breathing are made accessible by the bronchi.

The polymer phase comprises 5 to 25% by weight, based on the total amount of monomers, of one or more crosslinking agents.

The crosslinking reaction employed for the hypercrosslinking of the polyHIPEs according to the invention is, as already mentioned above, preferably multiple Friedel-Crafts alkylation. It is known that an electrophilic substitution by alkyl halides can take place on activated, electron-rich aromatic rings.

The reaction catalyst employed in accordance with the invention can be Lewis acids, such as aluminium chloride, iron chloride, zinc chloride or tin chloride, or protic acids (sulfuric acid, phosphoric acid). Preference is given in accordance with the invention to iron(III) chloride or aluminium chloride, where iron(III) chloride is particularly preferred.

If the reaction is catalysed by a Lewis acid, it must be carried out with exclusion of water in order to prevent deactivation of the catalyst. In principle, alcohols, alkyl tosylates or olefins can also be employed instead of alkyl halides for the Friedel-Crafts alkylation.

The literature often refers to the problem of multiple alkylation, which inevitably occurs in Friedel-Crafts alkylation. Due to the alkyl substituent introduced, the aromatic ring experiences additional activation, which favours further electrophilic substitutions on the ring and greatly restricts the selectivity of the reaction.

This effect is desired in the hypercrosslinking according to the invention, since the use of polyfunctional alkyl halides and multiple substitutions on the aromatic ring greatly increase the crosslinking density of the polymer, and microporosity is generated in this way.

The external electrophiles employed are frequently molecules containing chloromethyl groups, whose functionality must be at least two. Their flexibility and functionality can have a considerable influence on the later properties of the hypercrosslinked polyHIPEs.

It should furthermore be noted that a polycondensation network may be formed in the case of external electrophiles which themselves carry aromatic rings, in a competing reaction with Friedel-Crafts catalysis. In order to prevent this, aliphatic molecules are also used in accordance with the invention for the hypercrosslinking. Preference is given in accordance with the invention to the use of formaldehyde dimethyl acetal or chlorodimethyl ether.

The Friedel-Crafts alkylation is thermally initiated and proceeds in accordance with the invention at temperatures of about 80° C. in the liquid phase. It is important to use a solvent which on the one hand adequately dissolves (swells) the resultant polymer and on the other hand is inert to the Friedel-Crafts reaction (not an aromatic compound). A suitable solvent in accordance with the invention is 1,2-dichloroethane, but the use of hexane is also conceivable.

If the solvent is removed from the reaction after the Friedel-Crafts alkylation, the crosslinking products, which are now present in large number, mean that only limited shrinkage of the hypercrosslinked polymer can take place. Although a certain re-ordering of the chains is possible due to cooperative processes throughout the network, dense packing of the macromolecules, favoured by the van-der-Waals interaction between individual chain segments and the associated increase in energy, is, however, prevented. The arrangement of the network is similar to that of the swollen state and is permanently fixed by covalent linking. The network, even in the solvent-free state, is thus also characterised by a high proportion of free volume between the crosslinked polymer chains.

Preference is also given in accordance with the invention to hypercrosslinking by means of internal electrophiles. In this case, lightly pre-crosslinked precursor polymers, preferably based on 4-vinylbenzyl chloride (VBC) and divinylbenzene (DVB) or VBC/DVB/styrene in a defined molar ratio, are prepared, followed, as described above, by the Friedel-Crafts alkylation using the catalyst and utilising the chloromethyl functions of the VBC. The use of internal electrophiles enables better control via the crosslinking step and is therefore the preferred method in accordance with the invention over the use of external electrophiles.

In general, it is also possible to carry out crosslinking by combination of internal and external electrophiles.

Besides the Friedel-Crafts alkylation, it is also possible to carry out the hypercrosslinking of polyHIPEs using Friedel-Crafts acylation, in which thionyl chloride is employed for the linking of aromatic compounds. Sulfoxide bridges are formed in the network if the compound is brought to reaction twice.

It is also possible to utilise vinyl functions in the precursor polymer for hypercrosslinking. It can be shown that pre-crosslinked precursor polymers (in particular based on styrene/divinylbenzene) in some cases contain a significant number of vinyl groups which were not reacted during the free-radical pre-crosslinking.

With catalysis by AlCl₃, additional crosslinking of the vinyl groups with one another takes place via a cationic mechanism. The specific surface area of the material exhibits a significant increase after the reaction.

In order to produce the maximum surface area per volume unit of the monolithic material according to the invention, polyHIPEs having a proportion of the internal phase of 75.0% by vol. are prepared. This value is close to the theoretical limit of 74.0% by vol. which arises from a consideration of the spherical packing model. From this proportion by volume, the droplets of the emulsion are no longer in contact with one another, analogously to the spheres in closest spherical packing, meaning that windows which connect the individual voids of the polyHIPE to one another are no longer formed. A loss of the open porosity of the polyHIPE is therefore observed from this proportion by volume.

Porous substances are divided in accordance with the distance d between two opposite pore walls into microporous (d<2.0 nm), mesoporous (2.0 nm<d<50.0 nm) and macroporous (d>50.0 nm) materials.

The open-pored polymer foams according to the invention (polyHIPEs) contain pores, in particular storage and transport pores, where storage pores (micropores) are defined as pores which have a diameter of 0.1 nm to 4 nm, preferably 0.5 nm to 3 nm. Transport pores (micropores) are defined as pores which have a diameter of 0.1 μm to 2 μm, preferably 0.2 μm to 1 μm. The presence of storage and transport pores can be checked by sorption measurements, with the aid of which the uptake capacity of the open-pored polymer foams for nitrogen at 77 K can be measured, in accordance with DIN 66131.

The specific surface area, as calculated in accordance with the Langmuir model, is, in accordance with the invention, between 1000 and 3500 m²/g.

It is more preferably between 1200 and 3500 m²/g and most preferably between 1600 and 3400 m²/g.

The size of the pores and the pore connections can be controlled in accordance with the invention via the synthesis parameters. The latitude for adjustment of the pores here is significantly greater than in the case of similar inorganic systems, such as, for example, zeolites.

The invention furthermore relates to a process for the preparation of open-pored polymer foams comprising the steps of:
a) provision of an emulsion, preferably an O/W emulsion, comprising a continuous oil phase, which comprises at least one ethylenically unsaturated monomer, and an aqueous phase, which comprises at least one initiator and at least one electrolyte,
b) polymerisation of the emulsion to give the porous polymer,
c) hypercrosslinking of the porous polymer comprising a polymer phase and pores to give additional crosslinking bridges.

The oil phase of the emulsion according to the invention forms a mixture of the respective ethylenically unsaturated monomers during preparation of the polyHIPEs, These monomers are preferably selected from the group of divinylbenzene, 4-vinylbenzyl chloride, chloromethylstyrene, vinylpyridine and/or styrene, where binary and ternary systems are preferred in accordance with the invention. The polymer phase of the monolith according to the invention is thus built up from monomers selected from the group of divinylbenzene, 4-vinylbenzyl chloride, chloromethyistyrene, vinylpyridine and/or styrene. It is particularly preferably built up from the three monomers 4-vinylbenzyl chloride, styrene and divinylbenzene.

An initiator, preferably an alkali metal peroxodisulfate, such as potassium peroxodisulfate, and an electrolyte, preferably an alkali metal sulfate, such as potassium sulfate, are dissolved in the aqueous phase. A crosslinking agent, for example the nonionic surfactant sorbitan monooleate (Span 80), serves for stabilisation of the emulsion in the oil phase. The surfactant is combined with the oil phase at the beginning of the preparation, and the aqueous phase is then slowly added dropwise with stirring. At the end, the finished emulsion is stable even without the input of mechanical energy and is polymerised to completion in sealed vessels of any desired geometry.

Since the stability of the emulsion is partially determined by the monomers employed and their ratio to one another, slight changes in the composition can result in destabilisation of the system. If, for example, 4-vinylbenzyl chloride and DVB are employed as monomers in the oil phase, the proportion of DVB must be at least 25.0 mol % (based on the total amount of monomer) in order to produce a stable emulsion.

In order nevertheless to prepare starting materials based on these monomers having a low crosslinking agent content, some of the bifunctional crosslinking agent has been replaced by styrene. The polarity of DVB and styrene can be regarded as similar, meaning that mutual exchange of the monomers should not result in a significant effect on the emulsion properties. It is thus possible to prepare polyHIPEs which can be referred to as terpolymers comprising VBC, DVB and styrene. Preference is given to materials comprising 2.5 and 5.0 mol % of DVB, which ensures high swellability before the subsequent hypercrossiinking via the internal electrophile of the polyHIPE.

In order to have higher affinity to the gases to be stored, the open-pored polymer foam may, in a further embodiment, additionally comprise a nitrogen-containing monomer, preferably a pyridine derivative, such as, for example, vinylpyridine.

The present invention furthermore relates to a device for the uptake and/or storage and/or release of at least one gas, comprising a supported metal-organic framework material consisting of a combination of metal-organic framework material and open-pored polymer foams.

The device according to the invention may comprise the following further components:
a container which accommodates the metal-organic framework material;
an aperture for feed or discharge, which allows at least one gas to enter the device or leave the device;
a gas-tight accommodation mechanism which is capable of keeping the gas under pressure inside the container.

The present invention furthermore relates to stationary, mobile or portable equipment which comprises the device according to the invention.

The present invention furthermore relates to the use of the open-pored polymer foams according to the invention as gas storage material. In a preferred embodiment, the polymer foams according to the invention are employed for the storage of hydrogen and natural gas, preferably methane.

The present invention also relates to the use of the porous polymeric monoliths according to the invention as storage medium for gases, as adsorbent, as support material in chromatographic applications or catalytic processes, as material in machine construction or in medical technology.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and in the examples, the added amounts of the components in the compositions always add up to a total of 100%. Percentage data given should always be regarded in the given context. However, they usually always relate to the weight of the part- or total amount indicated.

### EXAMPLES

1. Preparation of polyHIPEs

### Example 1

### PolyHIPEs Based on 4-vinylbenzyl chloride and divinylbenzene (2)

4.67 ml (5.06 g, 33.14 mmol) of 4-vinylbenzyl chloride and 1.58 ml (1.44 g, 11.05 mmol) of divinylbenzene are initially introduced in a round-bottom flask. The total volume of the oil phase is 6.25 ml. 2.44 g (5.69 mmol) of the surfactant Span 80 are subsequently added. The aqueous phase (18.75 ml), which comprises 0.20 g (1.19 mmol) of the initiator potassium peroxodisulfate and 0.22 g (1.27 mmol) of the electrolyte potassium sulfate, is then slowly added dropwise with vigorous stirring. The resultant creamy emulsion is transferred into a sealable PE vial and polymerised to completion therein at 60° C. for several hours. For purification, the polyHIPE is washed with a water/2-propanol mixture (volume ratio 70/30) in a Soxhlet extractor for 24 h. The monolith is subsequently dried at 80° C. in vacuo to constant weight. Theoretical content of chloromethyl groups: 5.1 mmol/g.

### Example 2

### PolyHIPE Based on 4-vinylbenzyl chloride, styrene and divinylbenzene (1)

4.45 ml (4.81 g, 31.54 mmol) of 4-vinylbenzyl chloride, 1.47 ml (1.34 g, 12.85 mmol) of styrene and 0.33 ml (0.3 g, 2.34 mmol) of divinylbenzene are initially introduced in a round-bottom flask. The total volume of the oil phase is 6.25 ml. 2.42 g (5.65 mmol) of the surfactant Span 80 are subsequently added. The aqueous phase (18.75 ml) which comprises 0.2 g (1.18 mmol) of the initiator potassium peroxodisulfate and 0.22 g (1.27 mmol) of the electrolyte potassium sulfate is then slowly added dropwise with vigorous stirring. The resultant creamy emulsion is transferred into a sealable PE vial and polymerised to completion therein. For purification, the polyHIPE is washed with a water/2-propanol mixture (volume ratio 70/30) in a Soxhlet extractor for 24 h. The monolith is subsequently dried at 80° C. in vacuo to constant weight. Theoretical content of chloromethyl groups: 4.9 mmol/g.

### Example 3

### PolyHIPE Based on styrene and divinylbenzene (3)

5.86 ml (5.33 g, 51.22 mmol) of styrene and 0.39 ml (0.35 g, 2.70 mmol) of divinylbenzene are initially introduced in a round-bottom flask. The total volume of the oil phase is 6.25 ml. 2.13 9 (4.97 mmol) of the surfactant Span 80 are subsequently added. The aqueous phase (18.75 ml) which comprises 0.17 9 (1.04 mmol) of the initiator potassium peroxodisulfate and 0.22 9 (1.27 mmol) of the electrolyte potassium sulfate is then slowly added dropwise with vigorous stirring. The resultant creamy emulsion is transferred into a sealable PE vial and polymerised to completion therein at 60° C. in an oven for several hours. For purification, the polyHIPE is washed with a water/2-propanol mixture (volume ratio 70/30) in a Soxhlet extractor for 24 h. The monolith is subsequently dried at 80° C. in vacuo to constant weight. Theoretical aromatic content: 9.5 mmol/g.

2. Hypercrosslinking of polyHIPEs (via chloromethyl function, from Examples 1 and 2)

### Example 4

### Hypercrosslinking by Means of Iron(III) Chloride as Friedel-Crafts Catalyst

A piece (0.25 g) of the polyHIPE 1 or 2 produced above is swollen in 40 ml of 1,2-dichloroethane for about 30 minutes.

The apparatus is rendered inert via an argon connection on the condenser, and anhydrous iron(III) chloride (0.99 g, 6.13 mmol for polyHIPE 1, 1.03 g, 6.38 mmol for polyHIPE 2) is added in a counterstream of argon.

The flask contents are subsequently warmed to 80° C. The reaction is carried out under reflux for 24 h.

A change in colour of the originally white polyHIPE occurs immediately after addition of the catalyst (initially orange, then red, finally black).

For purification, the hypercrosslinked polyHIPE is washed with a water/methanol mixture (volume ratio 70/30) in a Soxhlet extractor for 24 h. The monolith is subsequently dried at 80° C. in vacuo to constant weight. Externally, the material has an ochre colour, while the hypercrosslinked polyHIPE is cream-coloured internally.

### Example 5

### Hypercrosslinking by Means of Aluminum(III) Chloride as Friedel-Crafts Catalyst

A piece (0.25 g) of the polyHIPE 2 produced above is swollen in 40 ml of 1,2-dichloroethane for about 30 minutes.

The apparatus is rendered inert via an argon connection on the condenser, and 0.85 g (6.38 mmol) of anhydrous aluminium(III) chloride is added in a counterstream of argon.

The flask contents are subsequently warmed to 80° C. The reaction is carried out under reflux for 24 h.

Immediately after addition of the catalyst, the material takes on a black colour.

For purification, the hypercrosslinked polyHIPE is washed with a water/methanol mixture (volume ratio 70/30) in a Soxhlet extractor for 24 h. The monolith is subsequently dried at 80° C. in vacuo to constant weight. The material hypercrosslinked with catalysis by anhydrous aluminium(III) chloride has a darker colour and is significantly more fragile than polyHIPEs which are hypercrosslinked using iron(III) chloride.

3. Hypercrosslinking of polyHIPEs (via formaldehyde dimethyl acetal, from Example 3)

### Example 6

### Hypercrosslinking by means of Iron(III) chloride as Friedel-Crafts Catalyst

A piece (0.25 g) of the polyHIPE 3 produced above is swollen in 40 ml of 1,2-dichloroethane for about 30 minutes.

The apparatus is rendered inert via an argon connection on the condenser.

0.21 ml (0.18 g, 2.38 mmol) of formaldehyde dimethyl acetal is added. 0.38 g (2.38 mmol) of anhydrous iron(III) chloride is then added in a counterstream of argon.

The flask contents are subsequently warmed to 80° C. The reaction is carried out under reflux for 24 h.

A change in colour of the originally white polyHIPE takes place immediately after addition of the catalyst (initially orange, then red, finally black). For purification, the hypercrosslinked polyHIPE is washed with a water/methanol mixture (volume ratio 70/30) in a Soxhlet extractor for 24 h. The monolith is subsequently dried at 80° C. in vacuo to constant weight. Externally, the material has an ochre colour, while internally the hypercrosslinked polyHIPE is cream coloured.

1. Porous, polymeric monolith obtainable by polymerisation of a high internal phase emulsion comprising:
a) a continuous oil phase which comprises at least one ethylenically unsaturated monomer, and
b) an aqueous phase comprising at least one initiator and at least one electrolyte,
where the porous polymer formed thereby, comprising a polymer phase and pores, is subsequently hypercrosslinked to give additional crosslinking bridges.

2. Porous, polymeric monolith according to claim 1, characterised in that the pores take up at least 74% by vol., preferably 75 to 90% by vol., of the total volume.

3. Porous, polymeric monolith according to claim 1, characterised in that the polymer phase comprises 5 to 25% by weight, based on the total amount of monomers, of one or more crosslinking agents.

4. Porous, polymeric monolith according to claim 1, characterised in that the polymer phase is built up from at least one ethylenically unsaturated monomer selected from the group of divinylbenzene, 4-vinylbenzyl chloride, chloromethylstyrene, vinylpyridine and/or styrene.

5. Porous, polymeric monolith according to claim 4, characterised in that the polymer phase is built up from the three monomers 4-vinylbenzyl chloride, styrene and divinylbenzene.

6. Porous, polymeric monolith according to claim 1, characterised in that it has a specific surface area (by the BET method) of 1000 to 3500 m²/g.

7. Porous, polymeric monolith according to claim 1, characterised in that the crosslinking bridges are formed during the hypercrosslinking by means of catalysis by Lewis acids, such as FeCl₃, AlCl₃, ZnCl₂, SnCl₄, or protic acids, such as H₂SO₄ or H₃PO₄, and chloromethylstyrene units in the polymer phase.

8. Porous, polymeric monolith according to claim 1, characterised in that the crosslinking bridges are formed during the hypercrosslinking by means of catalysis by Lewis acids, such as FeCl₃, AlCl₃, ZnCl₂, SnCl₄, or protic acids, such as H₂SO₄ or H₃PO₄, and a bifunctional reagent, such as formaldehyde dimethyl acetal.

9. Process for the preparation of an open-pored polymer foam comprising the steps of:
a) provision of an emulsion, preferably an O/W emulsion, comprising a continuous oil phase, which comprises at least one ethylenically unsaturated monomer, and an aqueous phase, which comprises at least one initiator and at least one electrolyte,
b) polymerisation of the emulsion to give the porous polymer,
c) hypercrosslinking of the polymerised polymer comprising a polymer phase and pores to give additional crosslinking bridges.

10. Process according to claim 9, characterised in that the hypercrosslinking is carried out with catalysis by Lewis acids, such as FeCl₃, AlCl₃, ZnCl₂, SnCl₄, or protic acids, such as H₂SO₄ or H₃PO₄, and chloromethylstyrene units.

11. Process according to claim 9, characterised in that the hypercrosslinking is carried out with catalysis by Lewis acids, such as FeCl₃, AlCl₃, ZnCl₂, SnCl₄, or protic acids, such as H₂SO₄ or H₃PO₄, and a bifunctional reagent, such as formaldehyde dimethyl acetal.

12. Process according to claim 9, characterised in that a crosslinking agent (surfactant) is additionally added to the oil phase.

13. Process according to claim 9, characterised in that alkali metal sulfates or alkali metal peroxodisulfates are employed as electrolyte and initiator in the aqueous phase.

14. Process according to claim 9, characterised in that divinylbenzene, 4-vinylbenzyl chloride, chloromethylstyrene, vinylpyridine and/or styrene are employed as ethylenically unsaturated monomers in the oil phase.

15. Device suitable for the uptake and/or storage and/or release of at least one gas, comprising a porous, polymeric monolith according to claim 1.

16. Device according to claim 15, characterised in that it additionally comprises a container which accommodates the porous, polymeric monolith, an aperture or outlet which enables the at least one gas to enter the device or leave the device, a gas-tight accommodation mechanism which is capable of keeping the gas under pressure inside the container.

17. Stationary, mobile or portable equipment comprising a device according to claim 15.

18. A storage medium for gases, adsorbent, support material in chromatographic applications or catalytic processes, material in machine construction or in medical technology, comprising porous, polymeric monoliths according to claim 1.
